(19) United States
(12) Patent Application Publication
(10) Pub. No.: US 2024/0311915 A1
(43) Pub. Date: Sep. 19, 2024

(54) SYSTEMS AND METHODS FOR INCENTIVIZING BEHAVIOR USING DATA PROJECTION

(71) Applicant: Wells Fargo Bank, N.A., San Francisco, CA (US)

(72) Inventor: Himanshu Baral, Fremont, CA (US)

(21) Appl. No.: 18/182,901

(22) Filed: Mar. 13, 2023

(51) Int. Cl. G06Q 40/06

(52) U.S. Cl. CPC G06Q 40/06

(57) ABSTRACT

Systems, apparatuses, methods, and computer program products are disclosed for incentivizing behavior using data projection. An example method includes deriving, by an investment profile analysis engine, a target investment interest for an individual and identifying, by an investment profile identification engine, one or more actions for the individual that are associated with the target investment interest. The example method further includes generating, by a data projection engine and based on the target investment interest, a future state projection, wherein the future state projection relates to the target investment interest presuming completion of the one or more actions and causing, by a communications hardware, presentation of the future-state projection to the individual.

### BACKGROUND

Personalizing the customer experience can enhance the relationship between an entity and its customers. However, it has traditionally been challenging to scale personalization of customer engagement without human involvement.

### BRIEF SUMMARY

In general, embodiments provided herein set forth solutions that use personalized data projections to incentivize behavior.

As discussed above, personalizing the customer experience is beneficial both to an entity and to its customers. Effective personalization often makes customers feel more valued, which inspires greater loyalty to (and repeat engagement with) the entity. However, sophisticated personalization has historically only been possible through manual intervention. And while efforts have been made to implement basic personalization solutions via automated processes in the recent past (e.g., recommending a new product based on a user's purchasing history), such methods have not approached the level of sophistication of human-driven approaches. In turn, sophisticated personalization has not been traditionally available for deployment to the mass market.

To provide a personalized experience for individuals, many entities utilize multiple forms of personalization. For example, an entity may employ rule-based personalization that personalizes experiences to specific segments of people (e.g., wide group of individuals, a niche group, or the like). An entity may use several simple, predetermined (by the entity) and easily adjusted rules that may divide a variety of individuals into smaller segments of individuals. The smaller segments may then be targeted for personalization associated with the rules that segregated the individuals into their smaller segments. For example, an individual who expressed interest in sustainability may be segregated into a smaller segment. Individuals included in the smaller segment may be approached with products related to sustainability. However, a rules-based approached to personalization is often restricted to personalization of segments of a population (e.g., a niche group, a broad group, or the like). For example, it is usually not efficient (computationally or financially) to compile a set of personalization rules that apply to only a single individual. The use of machine-learning personalization methods that base personalization on previous individual interactions (e.g., stored data) with an entity can avoid these problems, but such an approach presents problems of its own, in that stored data about an individual may degrade over time.

Example embodiments described herein mitigate the above concerns using generative artificial intelligence to produce sophisticated and personalized data projections to incentivize behavior. Example embodiments may derive a target investment interest for an individual. For example, example embodiments may generate a projection of an investment profile into a future state. The projection of the investment profile may be produced by a first machine learning model that implements a conditional generative adversarial network (cGAN). In addition, example embodiments may leverage a similarity model to process the future investment profile generated by the cGAN. Example embodiments may then derive a target investment interest for an individual through comparative analysis techniques that compare the future investment profile to a variety of individual investment profiles included in a collective dataset and, based on the comparison, identify a most-similar investment profile. Example embodiments may derive the target investment interest from the specific investment interests of the most-similar investment profile.

Example embodiments may also query an individual for their target investment interest requesting a specific investment interest and then receiving a specific investment interest from the individual in response. Example embodiments may process the individual response to define a target investment interest based on the received specific investment interest. In addition, example embodiments may utilize the specific investment interest received from the individual to verify a target investment interest derived from a data projection of the individual profile.

Example embodiments described herein may then personalize an individual experience by generating a projection based on the individual's target investment interest. The projection associated with the target investment may comprise a future-state projection presuming completion of one or more actions associated with the target investment interest. The future-state projection may be produced by a second machine learning model that implements a conditional generative adversarial network (cGAN). The future-state projection may describe the state of a target investment interest assuming completion of one or more actions by (i) the individual or (ii) a predetermined number of individuals. In some embodiments, generation of the future-state projection occurs in response to the completion of one or more actions associated with the target investment interest. Presenting the future-state projection to the individual can then incentivize behavior by the individual by illustrating an outcome that may be realized if they adopt the recommended behavior.

Accordingly, the present disclosure sets forth systems, methods, and apparatuses for incentivizing behavior using data projection. Through the use of data projection for incentivizing behavior, example embodiments mitigate the risk that personalization based on aged data will degrade over time. Moreover, such example embodiments avoid the need for resource-intensive rules-based personalization. Finally, personalizing content in this fashion enables deployment to a mass market of sophisticated personalization solutions that would not be feasible using a manual implementation given the magnitude of resources that a human-driven approach would require. Implementation of the embodiments described herein also provides enhanced flexibility over manual or legacy approaches, because more effective personalization may be generated through automated projection of an individual's investment profile than would be expected from either a rules-based approach (which would necessarily use predefined settings) or a manually driven approach (because a data-driven approach will necessarily avoid bias and be more closely tailored to each individual situation).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates a schematic block diagram of example conditional generative adversarial network (cGAN) training that may perform various operations in accordance with some example embodiments described herein.

FIG. 4 illustrates an example flowchart for incentivizing behavior using data projection, in accordance with some example embodiments described herein.

FIG. 5 illustrates an example flowchart for deriving a target investment interest associated with the individual from a collective dataset using data projection, in accordance with some example embodiments described herein.

FIG. 6 illustrates another example flowchart for deriving a target investment interest in response to querying an individual, in accordance with some example embodiments described herein.

FIG. 7 illustrates another example flowchart for compiling a series of investment interests and the associated investment milestones, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “target investment interest” refers to a future investment interest associated with an individual. In some embodiments, the target investment interest may describe stocks, bonds, mutual funds, exchange-traded funds, and/or the like. In some embodiments, the target investment interest may be a category that encapsulates an overall theme among a variety of stocks, bonds, mutual funds, exchange-traded funds, and/or the like. For example, a target investment interest may describe a risk factor that indicates the level of risk an individual may be comfortable investing with. In addition, a target interest may describe a particular industry (e.g., biotechnology, environmental, healthcare, etc.) that an individual may be interested in investing in. For example, a target investment interest for an individual who works in healthcare may be pharmaceutical and/or biotechnology stocks, mutual funds, or the like. In some embodiments, a target investment interest may be a combination of multiple investment interests. For example, an individual may have a specific investment interest in the environment and a low risk factor specific investment interest. As such, the target investment interest for the individual may be low risk environmental mutual funds, which combines the two main target investment interests associated with the individual.

The term “action” refers to a real-world step or operation. In some embodiments, the one or more actions may include investing in a target investment interest. In some embodiments the one or more actions may be popular actions taken by a variety of individuals. In addition, in some embodiments, the one or more actions may be predetermined and provided by a financial institution. For example, given a goal of environmentally sustainable investment, the one or more actions may include investing in companies prioritizing a green energy grid or divesting from companies producing many negative environmental externalities.

The term “future-state projection” refers to a simulated state relevant to the target investment interest. For example, a future-state projection for a target investment interest that is renewable energy may be a graphic (e.g., an interactive graph, or the like) indicative of the potential progress made towards a one hundred percent renewable energy grid if a certain number of individuals completed an action (e.g., investing in environmental funds, or the like).

The term “investment profile” refers to a data structure that describes information that may be used to identify an individual. In some embodiments, the investment profile may describe an individual's collection of assets. For example, the investment profile for an individual may include stocks, bonds, mutual funds, exchange-traded funds, and/or the like. In addition, the investment profile may include demographic data associated with an individual. For example, the investment profile may include data describing the individual's age, race, religion, level of education, occupation, income, marital status, or the like.

The term “future investment profile” refers to a simulated state of an investment profile. In some embodiments, the future investment profile may describe a projection of the entire investment profile. For example, the future investment profile may describe a simulation state of the individual's collection of assets and demographic data. Alternatively, the future investment profile may be focused on a specific component of the investment profile. For example, the future investment profile may only describe a simulate state of the individual's mutual fund investments.

The term “collective dataset” refers to a data structure that includes a variety of individual profiles that are each associated with a different individual. The collective dataset may include demographic data (e.g., age, race, religion, level of education, occupation, income, marital status, or the like) associated with each individual and the collection of assets associated with each individual (e.g., stocks, bonds, mutual funds, exchange-traded funds, and/or the like). In some embodiments, the collective dataset includes data originating from a financial institution, outside database, or the like.

The term “most-similar investment profile” refers to an investment profile that is the most alike to a future investment profile. In some embodiments, the most-similar investment profile may be an investment profile with greater similarity than other candidate investment profiles of demographic data (e.g., age, race, religion, level of education, occupation, income, marital status, or the like), asset allocation (e.g., stocks, bonds, mutual funds, exchange-traded funds, and/or the like), or other characteristics. In some embodiments, the most-similar investment profile may be an investment profile that is the most similar in a specific category of data without consideration of other categories of data. For example, assume an individual associated with a first set of demographic data primarily invests in biotechnology stocks. The most-similar investment profile may be for an individual that also primarily invests in biotechnology stocks despite having a second set of demographic data different from the first set of demographic data. Alternatively, in some embodiments, the most-similar profile may be an investment profile that is analogous to a predicted future individual investment profile of an individual rather than a current investment profile of the individual.

The term “specific investment interest” refers to data that describes a self-proclaimed target investment interest associated with an individual. In some embodiments, the specific investment interest associated with an individual may originate from the individual in response to querying the individual. In some embodiments, the specific investment interest may be associated with the individual's current target investment interest. Alternatively, the specific investment interest may be associated with a future investment interest specified by the individual. For example, the individual may describe the desire to be more philanthropic. The specific investment interest may then be defined to be more philanthropic.

The term “conditional generative adversarial network” refers to a machine learning network comprising two neural networks in contest with each other. The model may be a machine learning model that uses a conditional generative adversarial network (cGAN) that includes two neural networks, a generative machine learning model and a discriminator machine learning model, that are in contest with each other. In some embodiments, the generator and the discriminator may be machine learning models with convolutional neural networks. The generator and the discriminator may be trained in alternating periods. For example, the discriminator trains for one or more iterations while the generator remains constant, and then the generator trains for one or more iterations while the discriminator remains constant. In some embodiments, training of the cGAN initiates when the generator receives random noise to initiate generation of fake data. In some embodiments, the random noise may be sampled from a latent space and may be formatted as a vector, array, and/or the like. The introduction of random noise enables the generator to produce a wide variety of data, sampling from different places in a predefined target distribution. In addition to the random noise, a data label may be input that conditions the generator to a variety of authentication target types (e.g., facial images, signatures, aged data, current data or the like). The generator may generate synthetic data based on the input random noise and data label associated with the latent space where the random noise originates. Following generation of the synthetic data, the data label and synthetic data may be transmitted to discriminator. The discriminator may generate a probability based on the input data label and generated image. For example, if the discriminator is configured to output a probability of 0 for synthetic data, and a probability of 1 for a real data and the discriminator output a probability of 0.7 for the synthetic data, discriminator may update its weights through backpropagation based on a calculated error.

The term “series of investment interests” describes overall trends derived from the collective dataset. More specifically, the series of investment interests may be investment interests derived from data pertaining to the collection of assets and demographic data associated with the variety of individual profiles included in the collective dataset. In some embodiments, the series of investment interests may be the most popular one or more actions executed by individuals in the collective data set. In some embodiments, metadata associated with the most popular one or more actions may be utilized to derive a series of investment interests. For example, assume a multitude of individuals within the collective dataset have invested one percent of their income in small but different environmental companies. A series of investment interests derived from the above example may be the amount of disposable income invested into the environmental companies, individuals interested in the environment, investing in small businesses, or the like.

The term “set of investment milestones” describes financial goals associated with each particular investment interest included in the series of investment interests. In some embodiments, the set of investment milestones may be incremental milestones associated with an individual's one or more actions associated with their respective target interest. For example, a set of investment milestones may be to invest five hundred dollars into a target investment interest associated with the series of investment interests. In some embodiments, the set of investment milestones may be of a larger scale including a multitude of individuals. For example, an investment milestone may suggest investing five hundred dollars into a target investment interest associated with the series of investment interests. The investment milestone may further describe the effect of a multitude of individuals investing five hundred dollars towards the target investment interest.

### System Architecture

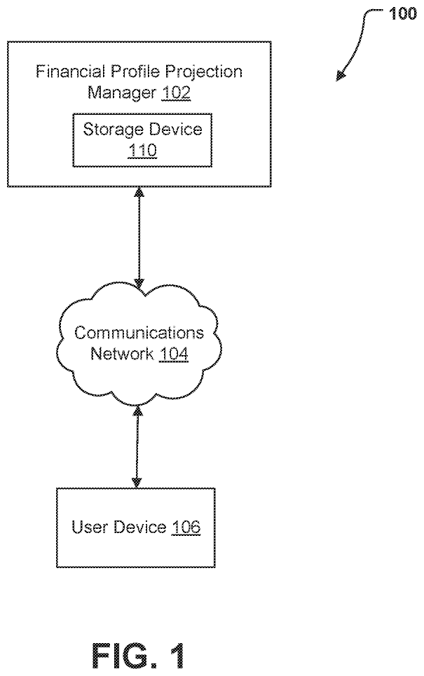

Example embodiments described herein may be implemented using any of a variety of computing devices or servers. To this end, FIG. 1 illustrates an example environment 100 within which various embodiments may operate. As illustrated, a financial profile projection manager 102 may receive and/or transmit information via communications network 104 (e.g., the Internet) with any number of other devices, such as one or more of user device 106.

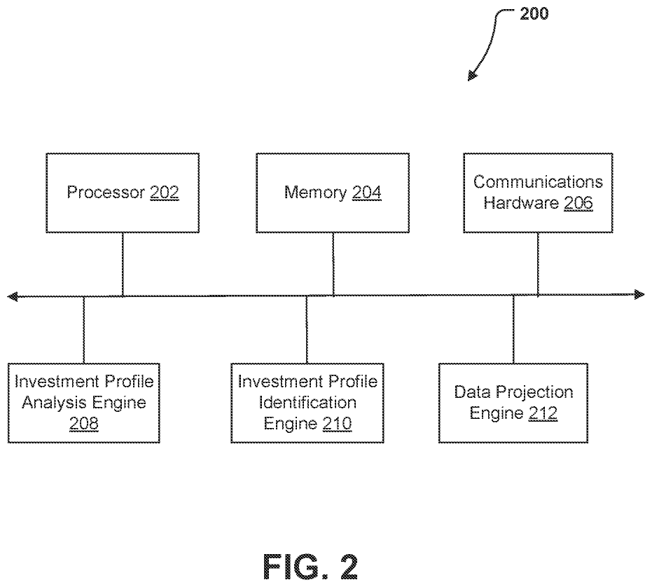

The financial profile projection manager 102 may be implemented as one or more computing devices or servers, which may be composed of a series of components. Particular components of the financial profile projection manager 102 are described in greater detail below with reference to apparatus 200 in connection with FIG. 2.

In some embodiments, the financial profile projection manager 102 further includes a storage device 110 that comprises a distinct component from other components of the financial profile projection manager 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the financial profile projection manager 102. Storage device 110 may store information relied upon during operation of the financial profile projection manager 102, such as various algorithms that may be used by the financial profile projection manager 102, data and documents to be analyzed using the financial profile projection manager 102, or the like. In addition, storage device 110 may store control signals, device characteristics, and access credentials enabling interaction between the financial profile projection manager 102 and user device 106.

The user device 106 may be embodied by any user devices known in the art, such as desktop or laptop computers, tablet devices, smartphones, or the like. The user device 106 need not itself be an independent device, but may be a peripheral device communicatively coupled to other computing devices. While described as a single device, user device 106 may include multiple user devices without departing from embodiments disclosed herein.

Although FIG. 1 illustrates an environment and implementation in which the financial profile projection manager 102 interacts indirectly with a user via one or more of user device 106, in some embodiments users may directly interact with the financial profile projection manager 102 (e.g., via communications hardware of the financial profile projection manager 102), in which case a separate user device 106 may not be utilized. Whether by way of direct interaction or indirect interaction via another device, a user may communicate with, operate, control, modify, or otherwise interact with the financial profile projection manager 102 to perform the various functions and achieve the various benefits described herein.

### Example Implementing Apparatuses

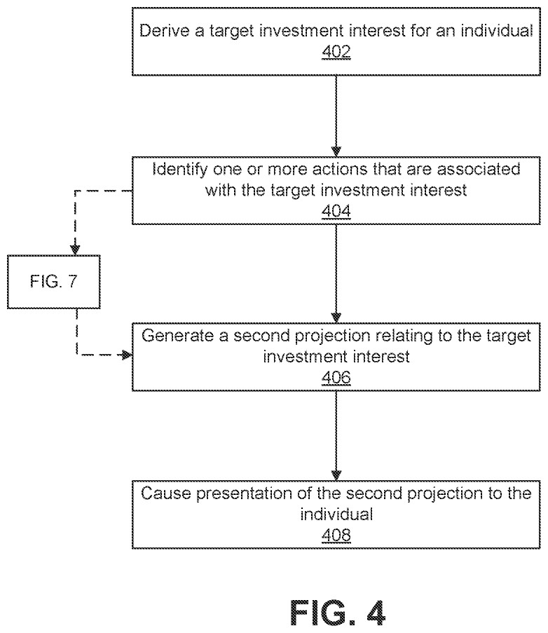

The financial profile projection manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-7. As illustrated in FIG. 2, the apparatus 200 may include processor 202, memory 204, communications hardware 206, investment profile analysis engine 208, investment profile identification engine 210, and data projection engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an investment profile analysis engine 208 that may be configured to derive a target investment interest for an individual. The investment profile analysis engine 208 may utilize processor 202, memory 204, or any other hardware component included in the apparatus 200 to perform these operations, as described in connection with FIGS. 4-7 below. The investment profile analysis engine 208 may further utilize communications hardware 206 to gather data from a variety of sources (e.g., user device 106, as shown in FIG. 1), and/or exchange data with a user, and in some embodiments may utilize processor 202 and/or memory 204 to perform any or more of the above operations.

In addition, the apparatus 200 further comprises an investment profile identification engine 210 that may be configured to identify one or more actions for the individual that are associated with the target investment interest. The investment profile identification engine 210 may utilize processor 202, memory 204, or any other hardware component included in the apparatus 200 to perform these operations, as described in connection with FIGS. 4-7 below. The investment profile identification engine 210 may further utilize communications hardware 206 to gather data from a variety of sources (e.g., user device 106, as shown in FIG. 1), and/or exchange data with a user, and in some embodiments may utilize processor 202 and/or memory 204 to perform any or more of the above operations.

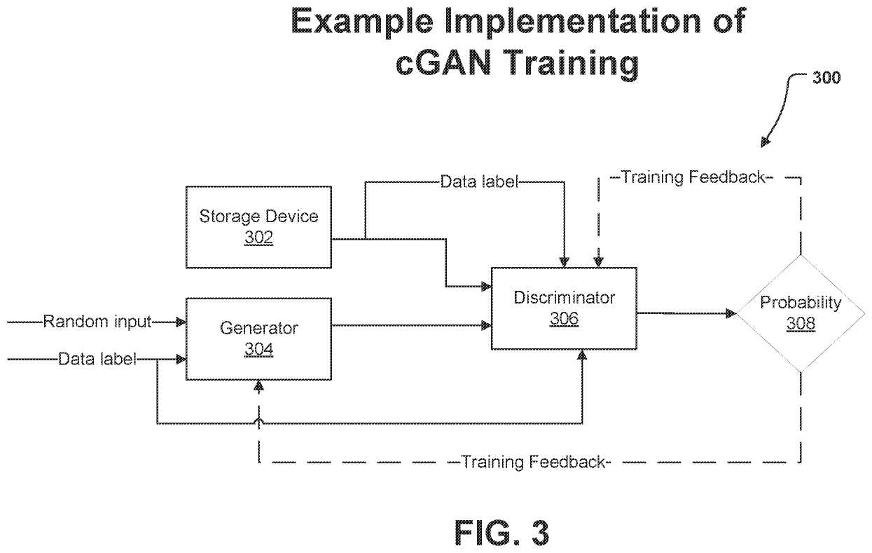

Further, the apparatus 200 further comprises data projection engine 212 that may be configured to generate a future investment profile projection. In particular, the data projection engine 212 may leverage a first machine learning model, such as a conditional generative adversarial network (cGAN), by applying the first machine learning model to an investment profile of an individual to produce a future investment profile. In addition, the data projection engine 212 may leverage a second machine learning model, such as a conditional generative adversarial network, by applying the second machine learning model to a target investment interest to produce a future state projection. The machine learning model and generative adversarial network are described in further detail below in connection with FIG. 3. The data projection engine 212 may utilize processor 202, memory 204, or any other hardware component included in the apparatus 200 to perform these operations, as described in connection with FIGS. 4-7 below. The data projection engine 212 may further utilize communications hardware 206 to gather data from a variety of sources (e.g., user device 106, as shown in FIG. 1), and/or exchange data with a user, and in some embodiments may utilize processor 202 and/or memory 204 to perform any or more of the above operations.

Although components 202-212 are described in part using functional language, it will be understood that the particular implementations necessarily include the use of particular hardware. It should also be understood that certain of these components 202-212 may include similar or common hardware. For example, the investment profile analysis engine 208, investment profile identification engine 210, and data projection engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “engine” with respect to elements of the apparatus therefore shall be interpreted as necessarily including the particular hardware configured to perform the functions associated with the particular element being described. Of course, while the term “engine” should be understood broadly to include hardware, in some embodiments, the term “engine” may in addition refer to software instructions that configure the hardware components of the apparatus 200 to perform the various functions described herein.

Although the investment profile analysis engine 208, investment profile identification engine 210, and data projection engine 212 may leverage processor 202, memory 204, or communications hardware 206 as described above, it will be understood that any of investment profile analysis engine 208, investment profile identification engine 210, and data projection engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that investment profile analysis engine 208, investment profile identification engine 210, and data projection engine 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG., that loading the software instructions onto a computing device or apparatus produces a special-purpose machine comprising the means for implementing various functions described herein.

Having described specific components of example apparatuses 200, example embodiments are described below in connection with a series of flowcharts.

### Conditional Generative Adversarial Network

Turning to FIG. 3, an example procedure 300 is illustrated for training a conditional generative adversarial network (cGAN). In some embodiments, the first machine learning model and the second machine learning model may comprise a cGAN that includes two neural networks, a generative machine learning model and a discriminator machine learning model, that are in contest with each other. In some embodiments, the generator and the discriminator may be convolutional neural networks.

In some embodiments, generator 304 and discriminator 306 may be trained in alternating periods. For example, the discriminator trains for one or more iterations while the generator remains constant, and then the generator trains for one or more iterations while the discriminator remains constant. The training may continue until the discriminator has a 50 percent chance of discriminating fake data generated from the generator model from real data. In some embodiments, training of the cGAN begins when the generator receives random noise to initiate generation of fake data. In some embodiments, the random noise may be sampled from a latent space and may be formatted as a vector, array, and/or the like. The introduction of random noise enables the generator 304 to produce a wide variety of data, sampling from different places in a predefined target distribution. In addition to the random noise, a data label may be input that conditions the generator 304 to a variety of authentication target types (e.g., facial images, signatures, aged data, current data, or the like). Generator 304 may generate synthetic data based on the input random noise and data label associated with the latent space where the random noise originates. Following generation of the synthetic data, the data label and synthetic data may be input to discriminator 306. The discriminator 306 may generate a probability based on the input data label and generated image describing the probability that the image was generated by generator 304 or the image is real (e.g., originating from storage device 302). For example, if discriminator 306 is configured to output a probability of 0 for synthetic data generated by generator 304, and a probability of 1 for real data from storage device 302 and the discriminator output a probability 308 of 0.7 for the received synthetic data, discriminator 306 may be notified it was incorrect causing discriminator 306 to update its weights through backpropagation based on a calculated error. Similarly, if discriminator 306 was correct, the generator would be notified it failed and would update its weights through back propagation based on a calculated error.

The error may be calculated based on any loss function known in the art. By means of continuing example, the error may be calculated based on a log-loss error function where generator 304 and discriminator 306 have two different log-loss error functions that prioritize generator 304 to cause the discriminator to output a probability of 1 for synthetic data and discriminator 306 to output a probability of 0 for a generated image. The derivative of the error function may be used to determine the weights of both the generator 304 neural network and the discriminator 306 neural network. In addition, after the weights are updated for generator 304 and/or discriminator 306 for a generated imaged based on random noise, a real image from storage device 302 may be input to discriminator 306 enabling discriminator 306 to train with real data. In some embodiments, following many iterations of training the cGAN network with both real data from storage device 302 and generated data based on random noise and a data label, the machine learning model may be applied to generate projections based on aged and current data. Although, the cGAN is described as a singular cGAN, there may be a plurality of cGAN's trained to be applied for generating a variety of projections for a variety of authentication targets (e.g., an image, a signature, or the like).

### Example Operations

Turning to FIGS. 4-7, example flowcharts are illustrated that contain example operations implemented by example embodiments described herein. The operations illustrated in FIGS. 4-7 may, for example, be performed by the financial profile projection manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, the investment profile analysis engine 208, investment profile identification engine 210, data projection engine 212, and/or any combination thereof. It will be understood that user interaction with the financial profile projection manager 102 may occur directly via communications hardware 206, or may instead be facilitated by a separate user device 106, as shown in FIG. 1, and which may have similar or equivalent physical componentry facilitating such user interaction.

Turning first to FIG. 4, example operations are shown for incentivizing behavior using data projection.

As shown by operation 402, the apparatus 200 includes means, such as memory 204, investment profile analysis engine 208, or the like, for deriving a target investment interest for an individual. A target investment interest may refer to a future investment interest associated with an individual. In some embodiments, the target investment interest may describe stocks, bonds, mutual funds, exchange-traded funds, and/or the like. In some embodiments, the target investment interest may be a category that encapsulates an overall theme amongst a variety of stocks, bonds, mutual funds, exchange-traded funds, and/or the like. For example, a target investment interest may describe a risk factor that indicates the level of risk an individual may be comfortable investing with. In addition, a target interest may describe a particular industry (e.g., biotechnology, environmental, healthcare, etc.) that an individual may be interested in investing in. For example, a target investment interest for an individual who works in healthcare may be pharmaceutical or biotechnology stocks, mutual funds, or the like. In some embodiments, a target investment interest may be a combination of multiple investment interests. For example, an individual may have a target investment interest in the environment and a low risk factor target investment interest. As such, the target investment interest for the individual may be low risk environmental mutual funds that combines the two main target investment interests associated with the individual.

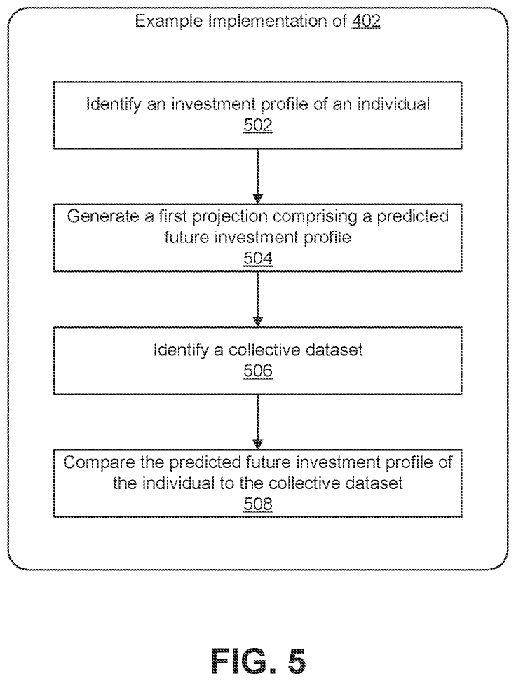

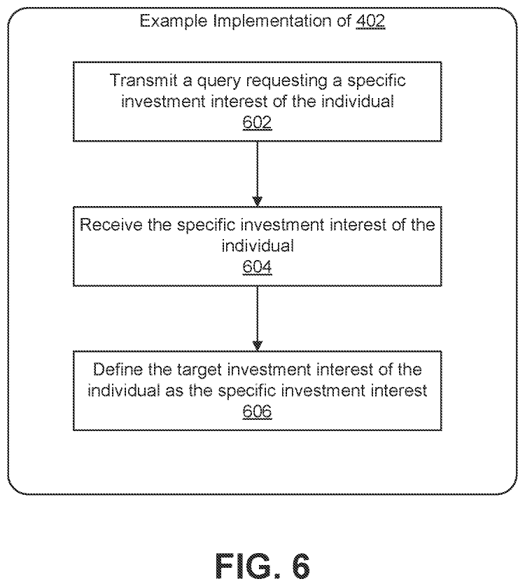

In some embodiments, investment profile analysis engine 208 may search for the target investment interest in a storage device (e.g., memory 204, storage device 110, or the like) if the target investment interest was recently derived. More specifically, the investment profile analysis engine 208 may search a database (e.g., a data structure such as a table of data stored in memory 204 of the apparatus) in a storage device for the target investment interest. The database may store the target investment interest and the individual associated with the target investment interest in the form of key-value pairs where the key portion specifies the individual, and the value portion specifies the target investment interest. In some embodiments, the stored target investment interest may degrade as it ages. In some embodiments, if the investment profile analysis engine 208 may determine if the target investment interest has decayed over time by referencing a set of target investment rules that specify the duration of time a target investment interest may be valid for an individual. In some embodiments, when no target investment interest is associated with the individual and/or the target investment interest is based on stale data that has decayed over time, investment profile analysis engine 208 may derive the target investment interest from a collective data set or query the individual for the target investment interest. These procedures are described in greater detail below in connection with FIG. 5 and FIG. 6.

Turning now to FIG. 5, example operations are shown for deriving a target investment interest associated with the individual from a collective dataset using data projection.

As shown by operation 502, the apparatus 200 includes means, such as memory 204, investment profile identification engine 210, or the like, for identifying an investment profile of an individual. An investment profile may be a data construct that describes information that may be used to identify an individual. In some embodiments, the investment profile may describe an individual's collection of assets. For example, the investment profile for an individual may include stocks, bonds, mutual funds, exchange-traded funds, and/or the like. In addition, the investment profile may include demographic data associated with an individual. For example, the investment profile may include data describing the individual's age, race, religion, level of education, occupation, income, marital status, or the like.

In some embodiments, investment profile identification engine 210 may search a storage device (e.g., memory 204, storage device 110, or the like) to identify the investment profile associated with an individual. For example, investment profile identification engine 210 may search a database (e.g., a data structure such as a table of data stored in storage device 110) for the investment profile associated with the individual. The database may store the investment profile and the individual associated with the investment profile in the form of key-value pairs where the key portion specifies the individual (e.g., an individual's name, unique individual identifier, or the like), and the value portion specifies the investment profile.

As shown by operation 504, the apparatus 200 includes means, such as memory 204, data projection engine 212, or the like, for generating an investment profile projection comprising a predicted future investment profile. The predicted future investment profile, hereinafter referred to as future investment profile, may describe a simulated state of an investment profile. In some embodiments, the future investment profile may describe a projection of the entire investment profile. For example, the future investment profile may include a projection of the individual's collection of assets and demographic data. In addition, the future investment profile may be focused on only a particular component of the investment profile. For example, the future investment profile projection may solely describe a simulate state of the individual's mutual fund investments.

In some embodiments, the data projection engine 212 may apply a first machine learning model to generate the investment profile projection. The applied first machine learning model may be a conditional generative adversarial network (cGAN) that includes two neural networks, a generative machine learning model and a discriminator machine learning model, that are in contest with each other. In some embodiments, the generator machine learning model and the discriminator machine learning model may be convolutional neural networks. The underlying mechanisms and models responsible for training the first machine learning model are described above in relation to FIG. 3.

In some embodiments, the trained cGAN may be leveraged by data projection engine 212 to generate an investment profile projection based on an investment profile associated with an individual. For example, the data projection engine 212 may retrieve the investment profile associated with the individual from a storage device (e.g., memory 204, storage device 110, or the like) and provide the investment profile to the cGAN to produce an investment profile projection that outputs a future investment profile. In addition, supplemental data may also be provided to the cGAN to produce the investment profile projection. In some embodiments, the supplemental data may describe the type of investment profile projection to be generated by the cGAN. For example, the difference in time between the investment profile and the predicted future investment profile may be input to the cGAN to determine the length of the investment profile projection. In addition, the supplemental data may instruct the cGAN to produce an investment profile projection of all components of the investment profile. For example, the supplemental data may instruct the cGAN to produce an investment profile projection of a portion of the investment profile, such that the demographic data, the collection of assets, or any combination of demographic data and the collection of assets (e.g., age, marital status, and mutual funds) are projected in a future investment profile.

As shown by operation 506, the apparatus 200 includes means, such as memory 204, communications hardware 206, investment profile identification engine 210, or the like, for identifying a collective dataset. In some embodiments, the collective dataset may be a data construct that includes a variety of individual profiles that are each associated with a different individual. The collective dataset may include demographic data (e.g., age, race, religion, level of education, occupation, income, marital status, or the like) and a collection of assets (e.g., stocks, bonds, mutual funds, exchange-traded funds, and/or the like) associated with each individual profile.

In some embodiments, investment profile identification engine 210 may retrieve a variety of individual profiles from data originating from a financial institution, outside database, or the like that may be appended to the collective dataset. Further, investment profile identification engine 210 may cause communications hardware 206 to access the variety of individual profiles from a data repository from a third-party via a network (e.g., communications network 104, FIG. 1). In some embodiments, investment profile identification engine 210 may use OCR, natural language processing, machine learning models (e.g., LSTM models) and/or the like to process text from data acquired via third parties to identify the variety of individual profiles and the data associated with the individual profiles (e.g., demographic, collection of assets, or the like). In some embodiments, the investment profiles retrieved from third parties may have personal identifiable information redacted. In some embodiments, the collective dataset may comprise of individual profiles retrieved from a local data repository (e.g., storage device 110, or the like). For example, a financial institution may have individual profiles associated with a variety of individuals (e.g., customers of the financial institution) in a storage device.

In some embodiments, the collective dataset is a full collective dataset, such that all combinations of demographics and collection of assets are present in at least one investment profile. In some embodiments, if a combination of demographics and collection of assets are not present in the collective dataset, the investment profile identification engine 210 may cause communications hardware 206 to query a storage device (e.g., storage device 110, or the like) and/or cause communications hardware 206 to access a variety of third-parties via a network (e.g., communications network 104, FIG. 1) to retrieve data to fill the collective dataset.

Finally, as shown by operation 508, the apparatus 200 includes means, such as memory 204, investment profile analysis engine 208, or the like, for comparing the predicted future investment profile of the individual to the collective dataset. In some embodiments, the comparison of the future investment profile to the variety of investment profiles included in the collective dataset may determine a most-similar investment profile. A most-similar investment profile may be an investment profile that is the most alike to an investment profile that is associated with an individual. In some embodiments, the most-similar investment profile may be an investment profile with similar demographic data (e.g., age, race, religion, level of education, occupation, income, marital status, or the like), similar collection of assets (e.g., stocks, bonds, mutual funds, exchange-traded funds, and/or the like), and/or the like. In some embodiments, the investment profile analysis engine 208 may be configured to that the most-similar investment profile may be an investment profile that is the most similar in a particular component of the investment profile, while ignoring other components of the investment profile. For example, assume an individual associated with a first set of demographic data only invests in biotechnology stocks. The most-similar investment profile may be an individual that also only invests in biotechnology stocks despite the most-similar investment profile comprising a second set of demographic data different from the first set of demographic data. Alternatively, in some embodiments, the most-similar profile may be an investment profile that is analogous with a predicted future investment profile.

In some embodiments, investment profile analysis engine 208 may reference data in a storage device (e.g., memory 204, storage device 110, or the like) that describes the inputs in the cGAN that were used to generate the future investment profile. In some embodiments, investment profile analysis engine 208 may use that data to identify the components of the future investment profile to prioritize when comparing the future investment profile to the variety of investment profiles included in the collective dataset. For example, assume a future investment profile was generated prioritizing a projection of the demographic data and investments in mutual funds. In the above example, while the investment profile analysis engine 208 filters through the variety of investment profiles, the investment profile analysis engine 208 may ignore assets that are not mutual funds included in the collection of assets (e.g., stocks, bonds, exchange-traded funds, and/or the like).

In some embodiments, the investment profile analysis engine 208 may determine the similarity of the future investment profile and the variety of investment profiles included in the collective dataset through a series of filtering operations. In particular, the future investment profile may be required to have similar demographic data and/or a similar collection of assets to be identified as the most-similar investment profile. Otherwise, even if the future investment profile has similar demographic data to a portion of the variety of investment profiles but drastically different collection of assets, the portion of the variety of investment profiles may not be determined as a most-similar investment profile. As such, by comparing the variety of investment profiles to the future investment profile prior to further evaluation of the variety of investment profiles, this provides a method of filtration that removes investment profiles that are not similar to the future investment profile, thus saving on computational resources and time by only further evaluating select investment profiles from the collective dataset.

In some embodiments, the investment profile analysis engine 208 may determine the most-similar investment profile by leveraging a similarity model. In some embodiments, the similarity model may be a machine learning or rules-based model that evaluates the similarity between data structures. In some embodiments the similarity model outputs a similarity score. A similarity score refers to a computed score describing the degree of similarity between two pieces of data (e.g., (i) a future investment profile and (ii) an investment profile included in the collective dataset). In some embodiments, the similarity score is a numerical score, which in other embodiments the similarity score may be converted into a categorical result (e.g., tier 1/tier 2/tier 3, green/yellow/red, or some other categorical classification).

In some embodiments, the future investment profile projection output from the cGAN may be input into a similarity scoring model that is configured to describe parameters, hyper-parameters, and/or stored operations of a model that is configured to process future investment profile, and/or variety of investment profiles to generate a similarity score based on the similarity between the future investment profile and another investment profile (e.g., an investment profile from the variety of investment profiles included in the collective dataset). In some embodiments, the similarity scoring model may utilize a hash function to map data (e.g., future investment profile and/or variety of investment profiles) of an arbitrary size to fixed-size values. For example, the similarity scoring model may generate a first array of a fixed-size associated with the future investment profile and generate a second array of a fixed-size associated with another investment profile. In some embodiments, the similarity scoring model may calculate a difference of the first array and second array to calculate Hamming distance indicative of the similarity between the two arrays. In some embodiments, the similarity score may be based on the calculated Hamming distance. In some embodiments, the investment profile analysis engine 208 may compare the Hamming distance associated with each investment profile included the collective dataset (that succeeded past the filtering method mentioned above) to identify a most-similar investment profile.

Turning next to FIG. 6, example operations are shown for querying an individual to derive a target investment interest.

As shown by operation 602, the apparatus 200 includes means, such as memory 204, communications hardware 206, investment profile analysis engine 208, or the like, for transmitting a query requesting a specific investment interest. A specific investment interest describes data that describes a self-proclaimed investment interest associated with an individual. In some embodiments, a specific investment interest may describe a self-proclaimed future investment interest. For example, an individual may describe the desire to be more philanthropic after the age of 50. Alternatively, the specific investment interest may describe an individual's current investment interests. For example, an individual may describe that they currently want to invest more in biotechnology.

In some embodiments, the investment profile analysis engine 208 may cause communications hardware 206 to transmit a specific investment interest request via a network (e.g., communications network 104, FIG. 1) to a computing device (e.g., user device 106). In some embodiments, investment profile analysis engine 208 may transmit the specific investment interest request in response to the activation of a specific investment interest trigger. The specific investment interest trigger may be a circumstantial trigger, temporal trigger, and/or the like that causes investment profile analysis engine 208 to initiate the transmission of a specific investment interest request. A circumstantial trigger event may describe rules and/or configurations that require a specific investment interest in response to a set of conditions and/or criteria being met. For example, a financial institution may compile a set of circumstantial trigger rules that describes the conditions that may activate a circumstantial trigger. A rule included in the set of circumstantial trigger rules that is violated may activate the circumstantial trigger. For example, if a comparison of the future investment profile and variety of investment profiles only yields weak similarity scores and/or only a small number (e.g., a number below a threshold described in the set of circumstantial trigger rules) of comparisons yields a strong similarity score, a circumstantial trigger may be activated causing the investment profile analysis engine 208 to initiate the transmission of the specific investment interest request to a computing device (e.g., user device 106) that is connected to the apparatus via a network (communications network 104, FIG. 1) to gather data about the individual's specific investment interest.

A temporal trigger may describe rules and/or configurations that require querying the individual for the individual for their specific investment interest within a particular time period or at a particular point in time. For example, investment profile analysis engine 208 may periodically (e.g., monthly) search a storage device (e.g., memory 204, storage device 110, or the like) for data describing the most recent specific investment interest submitted. If the investment profile analysis engine 208 determines that the most recent stored specific investment interest has degraded over time, a temporal trigger may be automatically activated causing the investment profile analysis engine 208 to initiate the transmission of the specific investment interest request to a computing device (e.g., user device 106) to gather data about the individual's specific investment interest.

As shown by operation 604, the apparatus 200 includes means, such as communications hardware 206, or the like, for receiving the specific investment interest of the individual. In some embodiments, the specific investment interest may be received by communications hardware 206. For example, the specific investment interest may be transmitted to the apparatus 200 from a separate computing device (e.g., a user device 106, or the like) that is connected to the apparatus 200 via a network (e.g., communications network 104, FIG. 1), which may be in response to the activation of a trigger that caused the transmission of the specific investment interest request (e.g., operation 602) to the separate computing device. As described above, a user may manually interact with a computing device, such as user device 106 via associated user interface(s), which in turn may cause the user device 106 to submit a specific investment interest. For example, a user may interact with the user device 106 to indicate a desire to begin investing in more sustainable companies now, such that the user device 106 may submit the specific investment interest and provide the specific investment interest to communications hardware 206 via a network (e.g., communications network 104, FIG. 1).

Finally, as shown by operation 606, the apparatus 200 includes means, such as memory 204, communications hardware 206, investment profile analysis engine 208, or the like, for defining the target investment interest of the individual. In some embodiments, investment profile analysis engine 208 may retrieve the specific investment interest from a storage device (e.g., memory 204, storage device 110, or the like). Alternatively, investment profile analysis engine 208 may receive the specific investment interest from communications hardware 206.

In some embodiments, one or more target investment interests may be derived from the specific investment interest. For example, assume an individual transmitted a specific investment interest describing that the individual wants to donate more money after the age of 50. The investment profile analysis engine 208 may derive target investment interests relating to philanthropy, investment tendencies after the age of 50, or the like. The specific investment interest may be formatted or otherwise configured with particular target investment interest parameter data fields and corresponding target investment interest data field values such that the apparatus 200 (e.g., via investment profile analysis engine 208) is configured identify and define one or more target investment interests based on the specific investment interest. In some embodiments, investment profile analysis engine 208 may use any suitable techniques to define a target investment interest included in the specific investment interest, such as optical character recognition (OCR), natural language processing (NLP), searching algorithms, machine learning models and/or the like.

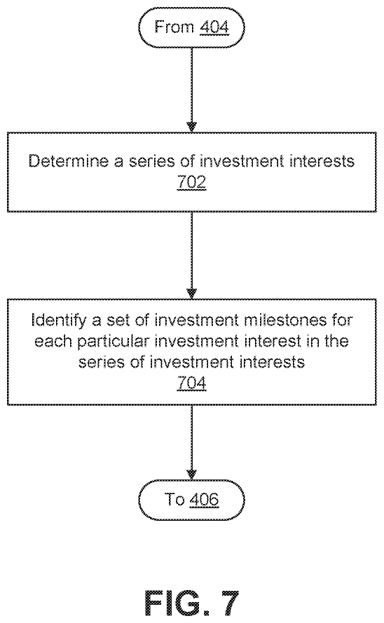

Returning to FIG. 4, as shown by operation 404, the apparatus 200 includes means, such as memory 204, investment profile identification engine 210, or the like, for identifying one or more actions for the individual that are associated with the target investment interest. In some embodiments, an action refers to a real-world step or operation. In some embodiments, the one or more actions may be predetermined and provided by a financial institution that is adjudicating the actions. For example, one or more actions may be one or more investments with companies prioritizing a green energy grid, where the companies may also be popular investments amongst a variety of individuals. Alternatively, in some embodiments, investment profile identification engine 210 may derive the one or more actions from a collective dataset. For example, investment profile identification engine 210 may retrieve the collective dataset from a storage device (e.g., memory 204, storage device 110, or the like) to search for the variety of investment profiles that share the same target interest as the individual. Identifying one or more actions related to the target investment interest from the collective dataset is described in further detail below in connection to FIG. 7.

In some embodiments, operation 404 may be followed by the operations described by FIG. 7. Turning now to FIG. 7, example operations are shown for determining one or more actions associated with an investment milestone.

As shown by operation 702, the apparatus 200 includes means, such as memory 204, investment profile analysis engine 208, or the like, for determining a series of investment interests. A series of investment interests may describe overall trends derived from the collective dataset. More specifically, the series of investment interests may be investment interests derived from the variety of investment profiles, which describe a collection of assets and demographic data, included in the collective dataset. For example, assume the collective dataset includes many individual profiles that invest in stocks, mutual funds, or the like associated with helping the environment (e.g., sustainability focused mutual funds). The investment profile analysis engine 208 may then determine an investment interest of sustainability and/or environmental stocks from the collective database.

In some embodiments, the investment profile analysis engine 208 may retrieve the collective dataset from a storage device (e.g., memory 204, storage device 110, or the like). In some embodiments, a specific investment interest is associated with each individual profile in the collective dataset in the form of key-value pairs, where the key specifies the individual profile, and the value portion specifies the series of investment interests. In some embodiments, investment profile analysis engine 208 may use any suitable technique to derive investment interests from the collective dataset. For example, investment profile analysis engine 208 may identify each investment interests associated with an individual investment profile included in the collective dataset. In addition, investment profile analysis engine 208 may calculate the frequency of repeated specific investment interests (e.g., a mode calculation) and define the top ten most frequent specific investment interests as a series of investment interests.

In some embodiments, investment profile analysis engine 208 may reference a set of rules stored in a storage device (e.g., memory 204, storage device 110, or the like) that list specific criteria that must be met to append a specific investment interest to a series of investment interests. For example, the set of rules may describe that a certain percentage of the collective dataset must be associated with the specific investment interest to append the specific investment interest to the series of investment interests. In some embodiments, a frequency threshold may be required to be met to add an investment interest to the series of investment interests. For example, a financial institution may predetermine a frequency threshold of one hundred that must be met to add an investment interest to the series of investment interests. Said another way, at least one hundred investment profiles are required to be associated with an investment interest to append the investment interest to the series of investment interests.

As shown by operation 704, the apparatus 200 includes means, such as memory 204, communications hardware 206, investment profile identification engine 210, or the like, for identifying a set of investment milestones for each particular investment interest in the series of investment interests. In some embodiments, the set of investment milestones may describe financial goals associated with each particular investment interest included in the series of investment interests. An investment milestone may refer to an individual goal or collective goal. For example, assume a particular investment interest in the series of investment interests is sustainability. An investment milestone associated with an individual goal may then describe allocating twenty percent of the individual's collection of assets in sustainable investments. Alternatively, for example, an investment milestone associated with a collective goal may describe investing a monetary amount (e.g., $100) into a fund associated with the target investment interest (e.g., sustainability) associated with the series of investment interests that may be selected by a financial institution adjudicating the investments. Further, the investment milestone associated with a collective goal may describe the impact of a number of individual profiles completing the same investment milestone. For example, assume a collective milestone involves investing in a mutual fund. In some embodiments, investment profile identification engine 210 may cause communications hardware 206 to transmit the investment milestone to the user via a network (communications network 104, FIG. 1) to a computing device (e.g., user device 106) that describes the investment milestone and the impact associated with a multitude of individual profiles completing the investment milestone.

In some embodiments, investment profile identification engine 210 may retrieve the specific investment interests derived from the collective dataset in a storage device (e.g., memory 204, storage device 110, or the like). In addition, the investment profile identification engine 210 may reference a set of milestones associated with popular specific investment interests in a storage device compiled by an entity (e.g., a business) adjudicating the investments. For example, the entity adjudicating the investments may reference a set of milestones and assign investment milestones to each particular investment interest included in the series of investment interests.

In some embodiments the investment profile identification engine 210 may use a web crawler to collect, gather, or otherwise aggregate information pertaining to a particular specific investment interest included in the series of investment interests, such as text describing investment milestones associated with the particular specific investment interest. The text may be identified using any suitable technique (e.g., OCR) and once identified, subsequently processed using any suitable technique (e.g., an LSTM model) to generate one or more investment milestones for the specific investment interests. For example, the investment profile identification engine 210 may use a web crawler to capture text describing an environmental stock and their respective water treatment goals and process the text to identify the environmental stock and the amount of money the environmental company requires to complete their water treatment goal. The investment profile identification engine 210 may then generate an investment milestone associated with the environmental company.

Returning to FIG. 4, as shown by operation 406, the apparatus 200 includes means, such as memory 204, data projection engine 212, or the like, for generating a future-state projection. A future-state projection may describe a simulated state of the target investment interest in response to completion of an action. In some embodiments, the future-state projection describes the impact of a completed action to incentivize behavior (e.g., repeat engagement). In some embodiments, the future-state projection incentivizes behavior by providing a positive reward to the individual for completing an action. For example, a future-state projection of a target interest that is renewable energy may be a graphic (e.g., an interactive graph, or the like) indicative of the potential progress made towards a one hundred percent renewable energy grid if a certain number of individuals completed an action (e.g., investing in environmental funds, or the like).

In some embodiments, the data projection engine 212 may apply a second machine learning model to generate the future-state projection. The applied second machine learning model may be a conditional generative adversarial network (cGAN) that includes two neural networks, a generative machine learning model and a discriminator machine learning model, that are in contest with each other. In some embodiments, the generator machine learning model and the discriminator machine learning model may be convolutional neural networks. The underlying mechanisms and models responsible for training the second machine learning model are described above in FIG. 3.

In some embodiments, the trained cGAN may be leveraged by data projection engine 212 to generate a future-state projection based on the target investment interest presuming completion of one or more actions. For example, in response to the apparatus 200 (e.g., communications hardware 206) receiving a request for one or more actions associated with the target investment interest, data projection engine 212 may retrieve an investment milestone associated with the target investment interest from a storage device (e.g., memory 204, storage device 110, or the like). The investment milestone may then be provided to the cGAN to produce the future-state projection. In some embodiments, the investment milestone may include supplemental data required to generate the future-state projection. For example, the supplemental data may describe the length of the future-state projection, the type of future-state projection (e.g., output an image, number, video, etc.), or the like.

Finally, as shown by operation 408, the apparatus 200 includes means, such as communications hardware 206, or the like, for causing presentation of the future-state projection to the individual. In some embodiments, the apparatus 200 may display the presentation of the future-state projection to the individual via communications hardware 206, or the future-state projection may be transmitted via communications network 104 to a user device 106. For example, following the completion of an action (e.g., via a user device 106) associated with the target investment interest, the future-state projection may be presented on the same computing device that completed the action (e.g., user device 106).

In some embodiments, the future-state projection may be presented to the individual in response to the individual completing one or more actions associated with an investment milestone. For example, assume an investment milestone is associated with environmental sustainability and an individual completed one or more actions that includes divesting from companies that produce many negative environmental externalities. The future-state projection may display a projection on the individual's computing device (e.g., user device 106) that indicates the impact of the completed one or more actions (e.g., a graph displaying lower carbon emissions).

In some embodiments, the future-state projection may be presented to the individual in response to the individual not completing one or more actions associated with an investment milestone. For example, assume an investment milestone is associated with combatting infectious diseases and the individual has not completed one or more actions that may include investing in companies focused on producing vaccines for various infectious diseases. The future-state projection may display a projection that describes the impact if the individual invested in companies focused on producing various vaccines (e.g., a graph displaying lowered infection rates). In some embodiments, the future-state projection may also describe the impact if many individuals complete one or more actions associated with the investment milestone.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved ability to personalize customer experience. Example embodiments thus provide tools that overcome the problems faced by traditional personalization techniques such as machine learning personalization based off stored data, rule-based personalization, or the like. By avoiding the use of traditional personalization techniques, example embodiments thus increase the efficiency and reliability of individualized personalization, while also eliminating the possibility of personalizing a customer experience based off old data. Moreover, embodiments described herein avoid difficulties associated with continuously updating baseline personalization information. Finally, by using generative artificial intelligence to create data projections for personalization that has historically required traditional personalization techniques, the efficiency and reliability of personalization performed by example embodiments unlocks many potential new functions that have historically not been available, such as the ability to incentivize behavior by presenting a future-state projection to the individual that illustrates an outcome that may be realized if an individual adopts a recommended behavior.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for incentivizing behavior using data projection, the method comprising:
deriving, by an investment profile analysis engine, a target investment interest for an individual;
identifying, by an investment profile identification engine, one or more actions for the individual that are associated with the target investment interest;
generating, by a data projection engine and based on the target investment interest, a future-state projection, wherein the future-state projection relates to the target investment interest presuming completion of the one or more actions; and
causing, by a communications hardware, presentation of the future-state projection to the individual.

2. The method of claim 1, wherein deriving the target investment interest comprises:
identifying, by the investment profile identification engine, an investment profile of the individual;
generating, by the data projection engine and based on the investment profile of the individual, an investment profile projection comprising a predicted future investment profile of the individual;
identifying, by the investment profile identification engine, a collective dataset, wherein the collective dataset comprises a set of investment profiles associated with a set of individuals; and
comparing, by the investment profile analysis engine, the predicted future investment profile of the individual to the set of investment profiles in the collective dataset to identify a most-similar investment profile from the set of investment profiles.

3. The method of claim 1, wherein deriving the target investment interest comprises:
transmitting, by the investment profile analysis engine, a query requesting a specific investment interest of the individual;
receiving, by the communications hardware, the specific investment interest of the individual; and
defining, by the investment profile analysis engine, the target investment interest of the individual as the specific investment interest.

4. The method of claim 2, wherein generating the investment profile projection comprises:
applying, by the data projection engine, a first machine learning model to the investment profile of the individual to produce the predicted future investment profile of the individual.

5. The method of claim 4, wherein the first machine learning model comprises a conditional generative adversarial network (cGAN).

6. The method of claim 1, wherein generating the future-state projection comprises:
applying, by the data projection engine, a second machine learning model to the target investment interest to produce the future-state projection.

7. The method of claim 6, wherein the second machine learning model comprises a conditional generative adversarial network (cGAN).

8. The method of claim 2, further comprising:
determining, by the investment profile analysis engine, a series of investment interests, wherein the series of investment interests are derived from the set of investment profiles in the collective dataset; and
identifying, by the investment profile identification engine, a set of investment milestones for each particular investment interest in the series of investment interests, wherein each investment milestone indicates a financial goal corresponding to the particular investment interest,
wherein causing generation of the future-state projection is based on the set of investment milestones for the target investment interest.

9. An apparatus for incentivizing behavior using data projection, the apparatus comprising:
an investment profile analysis engine configured to derive a target investment interest for an individual;
an investment profile identification engine configured to identify one or more actions for the individual that are associated with the target investment interest;
a data projection engine configured to generate based on the target investment interest, a future-state projection, wherein the future-state projection relates to the target investment interest presuming completion of the one or more actions; and
communications hardware configured to cause presentation of the future-state projection to the individual.

10. The apparatus of claim 9, wherein:
the investment profile identification engine is further configured to identify an investment profile of the individual;
the data projection engine is further configured to generate, based on the investment profile of the individual, an investment profile projection comprising a predicted future investment profile of the individual;
the investment profile identification engine is further configured to identify a collective dataset, wherein the collective dataset comprises a set of investment profiles associated with a set of individuals; and
the investment profile analysis engine is further configured to compare the predicted future investment profile of the individual to the set of investment profiles in the collective dataset to identify a most-similar investment profile from the set of investment profiles.

11. The apparatus of claim 10, wherein the data projection engine is further configured to:
apply a first machine learning model to the investment profile of the individual to produce the predicted future investment profile of the individual.

12. The apparatus of claim 11, wherein the first machine learning model comprises a conditional generative adversarial network (cGAN).

13. The apparatus of claim 9, wherein the data projection engine is further configured to:
apply a second machine learning model to the target investment interest to produce the future-state projection.

14. The apparatus of claim 13, wherein the second machine learning model comprises a conditional generative adversarial network (cGAN).

15. A non-transitory computer-readable storage medium storing instructions that, when executed by an apparatus, cause the apparatus to:
derive a target investment interest for an individual;
identify one or more actions for the individual that are associated with the target investment interest;
generate, based on the target investment interest, a future-state projection, wherein the future-state projection relates to the target investment interest presuming completion of the one or more actions; and
cause presentation of the future-state projection to the individual.

16. The non-transitory computer-readable storage medium of claim 15, wherein the instructions, when executed by the apparatus, further cause the apparatus to:
identify an investment profile of the individual;
generate, based on the investment profile of the individual, an investment profile projection comprising a predicted future investment profile of the individual;
identify, a collective dataset, wherein the collective dataset comprises a set of investment profiles associated with a set of individuals; and
compare the predicted future investment profile of the individual to the set of investment profiles in the collective dataset to identify a most-similar investment profile from the set of investment profiles.

17. The non-transitory computer-readable storage medium of claim 16, wherein the instructions, when executed by the apparatus, further cause the apparatus to:
apply, a first machine learning model to the investment profile of the individual to produce the predicted future investment profile of the individual.

18. The non-transitory computer-readable storage medium of claim 17, wherein the first machine learning model comprises a conditional generative adversarial network (cGAN).

19. The non-transitory computer-readable storage medium of claim 15, wherein the instructions, when executed by the apparatus, further cause the apparatus to:
apply, a second machine learning model to the target investment interest to produce the future-state projection.

20. The non-transitory computer-readable storage medium of claim 19, wherein the second machine learning model comprises a conditional generative adversarial network (cGAN).
